(19) United States
(12) Patent Application Publication
(10) Pub. No.: US 2026/0341941 A1
(43) Pub. Date: Oct. 29, 2026

(54) SYSTEM AND METHOD FOR RAPID EVACUATION OF FLUID COMPONENTS FROM A BATTERY CELL

(71) Applicant: GM GLOBAL TECHNOLOGY OPERATIONS LLC, Detroit, MI (US)

(72) Inventors: Daniel Ryan, Fenton, MI (US); Nicole Ellison, Southfield, MI (US); Jennifer T. Bracey, Holly, MI (US); Erik D. Huemiller, Troy, MI (US); Andrew C. Bobel, Troy, MI (US); John P. Spicer, Plymouth, MI (US)

(73) Assignee: GM GLOBAL TECHNOLOGY OPERATIONS LLC, Detroit, MI (US)

(21) Appl. No.: 19/190,919

(22) Filed: Apr. 28, 2025

(51) Int. Cl. H01M 50/691; F04B 19/04; H01M 50/342

(52) U.S. Cl. CPC H01M 50/691; F04B 19/04; H01M 50/3425

(57) ABSTRACT

A system and a method for rapid evacuation of fluid components from a battery cell include first and second puncturing elements for forming first and second holes in the battery cell with respective first and second channels extending through the puncturing elements, a first pressure source connected with the first channel, an evacuation manifold, and a second pressure source connected with the manifold inlet. The evacuation manifold has a housing enclosing a plenum, a manifold inlet and outlet formed in the housing, a through-hole formed in the housing between the manifold inlet and outlet, a conduit connected with the through-hole and terminating within the plenum downstream of the primary end, and a one-way valve disposed adjacent the conduit termination. The through-hole is aligned with the second channel, and the fluid components are caused to flow through the second hole, the second channel and the conduit and out the manifold outlet.

### INTRODUCTION

This disclosure relates generally to systems and methods for rapid evacuation of fluid components from a battery cell.

Battery cells, such as lithium ion batteries used in hybrid and electric automotive vehicles, are often sealed after they are filled with electrolyte. Over time, such batteries may also accumulate various gaseous and liquid by-products inside the battery cells.

When a battery cell has reached the end of its useful life, it may be desirable to remove the fluid contents that are sealed inside for recycling or other purposes. Currently, the only method of removing the fluid contents is to cut the battery cell open and allow the contents to drain out, but this is a slow and brute-force process. Moreover, there are no known methods for rapidly evacuating the electrolyte and fluid by-products from such sealed battery cells.

### SUMMARY

According to one embodiment, a system for rapid evacuation of fluid components from a battery cell includes: (i) a first puncturing element configured for interfacing with and puncturing a first surface of the battery cell to form a first hole through the first surface, and having a first channel extending through the first puncturing element; (ii) a second puncturing element configured for interfacing with and puncturing a second surface of the battery cell to form a second hole through the second surface, and having a second channel extending through the second puncturing element; (iii) a first pressure source in fluid communication with the first channel via a first conduit and configured to cause a first fluid flow through the first conduit and the first channel; (iv) an evacuation manifold having a housing enclosing a plenum, a manifold inlet and a manifold outlet each formed in the housing and in fluid communication with the plenum with a downstream direction defined from the manifold inlet to the manifold outlet, a through-hole formed in the housing between the manifold inlet and the manifold outlet, a second conduit having a primary end in fluid communication with the through-hole and a secondary end terminating within the plenum downstream of the primary end, and a one-way valve disposed adjacent the secondary end of the second conduit and configured to move between a closed position which prevents flow through the second conduit and an open position which permits flow through the second conduit; and (v) a second pressure source in fluid communication with the manifold inlet via a third conduit and configured to cause a second fluid flow through the third conduit and the plenum and out the manifold outlet. The evacuation manifold is configured to interface with the second puncturing element such that the through-hole is placed in fluid communication with the second channel, and the first and second fluid flows cause the fluid components to flow through the second hole, the second channel and the second conduit and out the manifold outlet.

The battery cell may be a prismatic battery cell or a cylindrical battery cell.

The first surface may be a top surface of the battery cell and the second surface may be a bottom surface of the battery cell. Alternatively, the first and second surfaces may be on a bottom surface of the battery cell.

At least one of the first puncturing element and the second puncturing element may be carried by or incorporated into the evacuation manifold.

The system may further include a holding frame having a top platen configured to interface with a top portion of the battery cell and a bottom platen configured to interface with a bottom portion of the battery cell, wherein the top and bottom platens are configured to cooperate together for securing the battery cell against movement.

The first puncturing element may be carried by or incorporated into the top platen, and the second puncturing element may be carried by or incorporated into the bottom platen.

The system may further include a vibrating member carried by or incorporated into at least one of the top platen and the bottom platen and configured for vibrating the battery cell.

The system may further include a first seal carried by the first puncturing element and configured for sealing against the first surface so as to prevent leakage between the first puncturing element and the first surface when the first puncturing element punctures the first surface, and a second seal carried by the second puncturing element and configured for sealing against the second surface so as to prevent leakage between the second puncturing element and the second surface when the second puncturing element punctures the second surface.

The system may further include an accumulator/separator for receiving the fluid components from the manifold outlet and for separating the fluid components into gas components and non-gas components.

The first fluid flow from the first pressure source may include at least one of an inert gas and a non-reactive gas that is not reactive with the fluid components or with any internal components of the battery cell.

The system may further include an inlet valve disposed in the first fluid flow and configured for at least one of dynamically variable flow and pulsing flow.

The first and second surfaces may be on a bottom wall of the battery cell, wherein the battery cell includes a first internal channel extending in a first leg along the bottom wall from a first closed end at a starting point adjacent the first surface to a first side wall of the battery cell and in a second leg upward along the first side wall to a first open end at a terminating point adjacent a top wall of the battery cell, and wherein the first hole is in fluid communication with the first internal channel.

The battery cell may include a second internal channel extending along the bottom wall from a second open end at a beginning point adjacent a second side wall generally opposite the first side wall to a second closed end at an ending point that is inward of the second side wall, and the second hole may be in fluid communication with the second internal channel.

The second puncturing element may include: (a) a tube having an upper wall, a lower wall, a first end wall at a first end of the tube defining a forward direction, and a second end wall at a second end of the tube defining a rearward direction, wherein the tube is generally sealed except for a tube inlet formed on the first end, a tube outlet formed in the lower wall and a slot formed in the upper wall; (b) a wedge sealably and slidably disposed within the tube between a forward position and a rearward position with a middle position between the forward and rearward positions, the wedge having a first wedge surface generally facing the forward direction and an upwardly sloping ramp surface generally facing the rearward direction, wherein a tube chamber is defined within the tube between the first end wall and the first wedge surface; (c) a generally vertical blade having an upper blade portion and a lower blade portion, wherein the lower blade portion is supported upon and is upwardly slidable along the ramp surface; (d) a piston sealably and slidably disposed within the tube and positioned rearward of the wedge; (e) a biasing member disposed between the blade and the piston; and (f) a third pressure source in fluid communication with the tube inlet.

In the forward position, a first pressure may be present in the tube chamber, the first wedge surface may be disposed forward of the tube outlet and the upper blade portion may extend to a first height above the slot.

Between the forward position and the middle position, a second pressure that is higher than the first pressure may be developed in the tube chamber by the third pressure source, thereby urging the wedge rearward while the piston remains unmoved and compressing the biasing member, thus causing the upper blade portion to extend to a second height above the slot that is greater than the first height, wherein the first wedge surface remains disposed forward of the tube outlet.

Between the middle position and the rearward position, a third pressure that is higher than the second pressure may be developed in the tube chamber by the third pressure source, thereby urging the wedge and the piston rearward while the upper blade portion maintains the second height, until the wedge is urged into the rearward position with the first wedge surface being disposed rearward of the tube outlet.

According to another embodiment, a system for rapid evacuation of fluid components from a battery cell includes: (i) a first puncturing element configured for interfacing with and puncturing a first surface of the battery cell to form a first hole through the first surface, and having a first channel extending through the first puncturing element; (ii) a second puncturing element configured for interfacing with and puncturing a second surface of the battery cell to form a second hole through the second surface, and having a second channel extending through the second puncturing element; (iii) a first pressure source in fluid communication with the first channel via a first conduit and configured to cause a first fluid flow through the first conduit and the first channel; (iv) an evacuation manifold having a housing enclosing a plenum, a manifold inlet and a manifold outlet each formed in the housing and in fluid communication with the plenum with a downstream direction defined from the manifold inlet to the manifold outlet, a through-hole formed in the housing between the manifold inlet and the manifold outlet, a second conduit having a primary end in fluid communication with the through-hole and a secondary end terminating within the plenum downstream of the primary end, and a one-way valve disposed adjacent the secondary end of the second conduit and configured to move between a closed position which prevents flow through the second conduit and an open position which permits flow through the second conduit; and (v) a second pressure source in fluid communication with the manifold inlet via a third conduit and configured to cause a second fluid flow through the third conduit and the plenum and out the manifold outlet. The second puncturing element includes: (a) a tube having an upper wall, a lower wall, a first end wall at a first end of the tube defining a forward direction, and a second end wall at a second end of the tube defining a rearward direction, wherein the tube is generally sealed except for a tube inlet formed on the first end, a tube outlet formed in the lower wall and a slot formed in the upper wall; (b) a wedge sealably and slidably disposed within the tube between a forward position and a rearward position with a middle position between the forward and rearward positions, the wedge having a first wedge surface generally facing the forward direction and an upwardly sloping ramp surface generally facing the rearward direction, wherein a tube chamber is defined within the tube between the first end wall and the first wedge surface; (c) a generally vertical blade having an upper blade portion and a lower blade portion, wherein the lower blade portion is supported upon and is upwardly slidable along the ramp surface; (d) a piston sealably and slidably disposed within the tube and positioned rearward of the wedge; (e) a biasing member disposed between the blade and the piston; and (f) a third pressure source in fluid communication with the tube inlet.

In the forward position, a first pressure is present in the tube chamber, the first wedge surface is disposed forward of the tube outlet and the upper blade portion extends to a first height above the slot. Between the forward position and the middle position, a second pressure that is higher than the first pressure is developed in the tube chamber by the third pressure source, thereby urging the wedge rearward while the piston remains unmoved and compressing the biasing member, thus causing the upper blade portion to extend to a second height above the slot that is greater than the first height, wherein the first wedge surface remains disposed forward of the tube outlet. And between the middle position and the rearward position, a third pressure that is higher than the second pressure is developed in the tube chamber by the third pressure source, thereby urging the wedge and the piston rearward while the upper blade portion maintains the second height, until the wedge is urged into the rearward position with the first wedge surface being disposed rearward of the tube outlet.

In this embodiment, the evacuation manifold is configured to interface with the second puncturing element such that the through-hole is placed in fluid communication with the second channel, and the first and second fluid flows cause the fluid components to flow through the second hole, the second channel and the second conduit and out the manifold outlet.

According to yet another embodiment, a method for rapidly evacuating fluid components from a battery cell includes: (i) puncturing a first surface of the battery cell with a first puncturing element having a first channel extending therethrough so as to form a first hole through the first surface; (ii) puncturing a second surface of the battery cell with a second puncturing element having a second channel extending therethrough so as to form a second hole through the second surface; (iii) interfacing an evacuation manifold having a housing with a through-hole formed therein with the second puncturing element such that the through-hole is placed in fluid communication with the second channel, wherein the housing encloses a plenum and the evacuation manifold has a manifold inlet and a manifold outlet each formed in the housing and in fluid communication with the plenum with a downstream direction defined from the manifold inlet to the manifold outlet and with the through-hole being disposed between the manifold inlet and the manifold outlet, a second conduit having a primary end in fluid communication with the through-hole and a secondary end terminating within the plenum downstream of the primary end, and a one-way valve disposed adjacent the secondary end of the second conduit and configured to move between a closed position which prevents flow through the second conduit and an open position which permits flow through the second conduit; (iv) causing a first fluid flow through the first channel by using a first pressure source having a first conduit in fluid communication with the first channel; and (v) causing a second fluid flow through the plenum and out the manifold outlet by using a second pressure source having a third conduit in fluid communication with the manifold inlet. In this method, the first and second fluid flows cause the fluid components to flow through the second hole, the second channel and the second conduit and out the manifold outlet.

The method may further include flushing the battery cell with a liquid that is not reactive with the fluid components or with any internal components of the battery cell. The flushing of the battery cell may include passing the liquid through the first puncturing element, the battery cell, the second puncturing element and the evacuation manifold.

The method may further include vibrating the battery cell by using a vibrating member that is carried by or incorporated into at least one of a top platen and a bottom platen of a holding frame, wherein the top platen is configured to interface with a top portion of the battery cell and the bottom platen is configured to interface with a bottom portion of the battery cell, wherein the top and bottom platens are configured to cooperate together for securing the battery cell against movement.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIGS. 1-2 are schematic cross-sectional elevation views of a battery cell before and after puncture of the battery cell, respectively.

FIG. 3 is a schematic cross-sectional elevation view of an alternative battery cell.

FIG. 4 is a block diagram of fluid components within a battery cell.

FIG. 5 is a schematic cross-sectional exploded view of a system for rapid evacuation of fluid components from a battery cell.

FIG. 6 is a schematic cross-sectional assembled view of the system shown in FIG. 5 with an accumulator added.

FIG. 7 is a schematic cross-sectional exploded view of an alternative embodiment of the system.

FIG. 8 is a schematic cross-sectional exploded view of another alternative embodiment of the system.

FIGS. 9-10 are schematic cross-sectional views of the tube of FIG. 8 as viewed along section A-A, and illustrating circular and rectangular tube shapes, respectively.

FIGS. 11-13 are schematic cross-sectional elevation views of a second puncturing element having a tube with a slidable wedge therein with the wedge shown in forward, middle and rearward positions, respectively.

FIGS. 14-16 are schematic perspective views of top and bottom platens of a holding frame in first, second and third configurations, respectively.

FIG. 17 is a block diagram of a system for rapid evacuation of fluid components from a battery cell.

FIG. 18 is a flowchart for a method for rapid evacuation of fluid components from a battery cell.

### DETAILED DESCRIPTION

Referring now to the drawings, wherein like numerals indicate like parts in the several views, a system 40 and method 100 for rapid evacuation of fluid components 33 from a battery cell 10 are shown and described herein.

The system 40 and method 100 may be used to puncture holes in a battery cell 10, as well as to rapidly remove the fluid components 33 from the punctured battery cell 10.

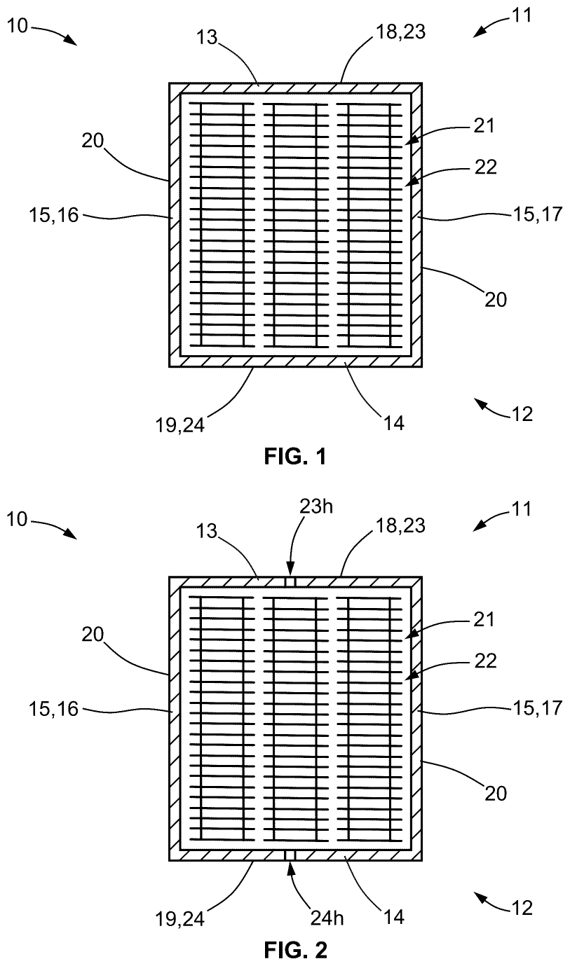

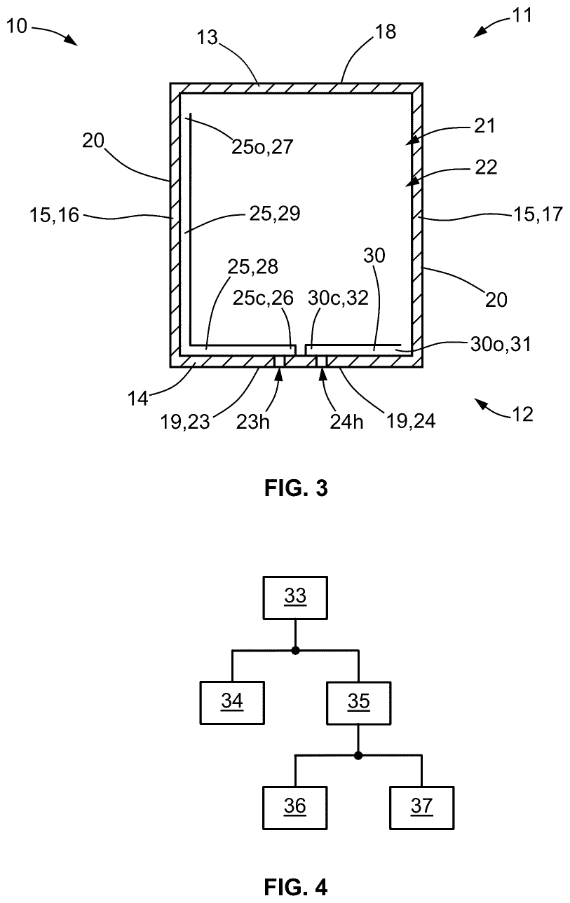

FIG. 1 shows a schematic cross-sectional elevation view of a battery cell 10 before puncture of the battery cell 10, and FIG. 2 shows the same view after puncture of the battery cell 10. Relatedly, FIG. 3 shows a schematic cross-sectional view of an alternatively constructed battery cell 10, after being punctured. (Note that in FIGS. 1-3, the positive and negative electrodes are not shown, and in FIG. 3, some of the internal components 22 have been omitted in order to provide room for additional reference numerals as compared to FIGS. 1-2.)

The battery cell 10 may be cylindrical or prismatic in shape, having a top wall 13 at a top portion 11 of the battery cell 10, a bottom wall 14 at a bottom portion 12 of the battery cell 10, and one or more side walls 15. For example, a cylindrical battery cell 10 may have one continuous side wall 15, while a prismatic battery cell 10 may have four side walls 15 (i.e., a front wall, a rear wall, a left wall and a right wall). Since the views shown in FIGS. 1-3 are cross-sectional, the battery cell 10 shown may be cylindrical or prismatic in shape; thus, the cross-sections of the side walls 15 shown as first and second side walls 16, 17 may be of the same, singular wall if the battery cell 10 is cylindrical, or they may be two distinct side walls 15 that are opposed to each other if the battery cell 10 is prismatic.

The top wall 13 has a top surface 18, and the bottom wall 14 has a bottom surface 19. Similarly, each side wall 15 has a respective side surface 20. The top, bottom and side walls 13, 14, 15 enclose and define an interior 21 within the battery cell 10, which may contain solid, liquid or gelatinous electrolyte along with various solid internal components 22 (e.g., charge plates, baffles, membranes, etc.).

As shown in FIGS. 1-2, a first surface 23 or region may be located on the top surface 18, and a second surface 24 or region may be located on the bottom surface 19. However, in other arrangements, the first and second surfaces 23, 24 or regions may both be located on the same overall surface, such as in FIG. 3 where both the first and second surfaces 23, 24 are located on the bottom surface 19. In either case, each of the first and second surfaces 23, 24 may be a targeted region or location that is a portion of (and thus smaller than) the overall surface on which each of the first and second surfaces 23, 24 is located. For example, in FIGS. 1-2, the first surface 23 may be a small portion of the overall top surface 18, and the second surface 24 may be a small portion of the overall bottom surface 19. Similarly, in FIG. 3, where both the first and second surfaces 23, 24 are located on the bottom surface 19, the first surface 23 may be a small first portion of the overall bottom surface 19, and the second surface 24 may be a small second portion of the overall bottom surface 19 that is different from the first portion.

FIG. 4 shows a block diagram of various fluid components 33 that may be found within a battery cell 10. The fluid components 33 may include one or more gas components 34 and one or more non-gas components 35—i.e., one or more liquid components and/or one or more solid components—with the non-gas components 35 including one or more electrolytes 36 (in solid, liquid or gelatinous forms) and/or other particulate matter 37 (e.g., solid pieces of debris, corrosion or the like from the internal components 22).

The locations of the first and second surfaces 23, 24 are carefully selected such that ample room is provided for a first puncturing element 41 to interface with the first surface 23 and for a second puncturing element 45 to interface with the second surface 24. Thus, with the battery cell configuration shown in FIGS. 1-2, a first puncturing element 41 may be interfaced with the first surface 23 on the top wall 13 or top surface 18 of the battery cell 10 and a second puncturing element 45 may be interfaced with the second surface 24 on the bottom wall 14 or bottom surface 19 of the battery cell 10, whereas with the battery cell configuration shown in FIG. 3, both the first and second puncturing elements 41, 45 may be interfaced with the respective first and second surfaces 23, 24 which are on the bottom wall 14 or bottom surface 19 of the battery cell 10. As described in more detail below, the first and second puncturing elements 41, 45 are interfaced with their associated first and second surfaces 23, 24 in order to produce respective first and second holes 23h, 24h through the walls of the battery cell 10 at the associated first and second surfaces 23, 24.

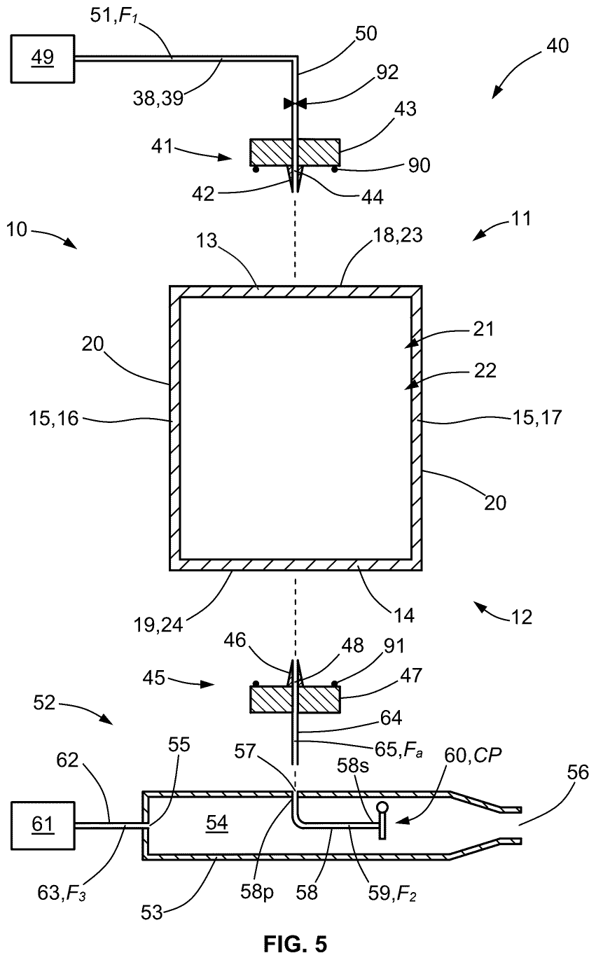

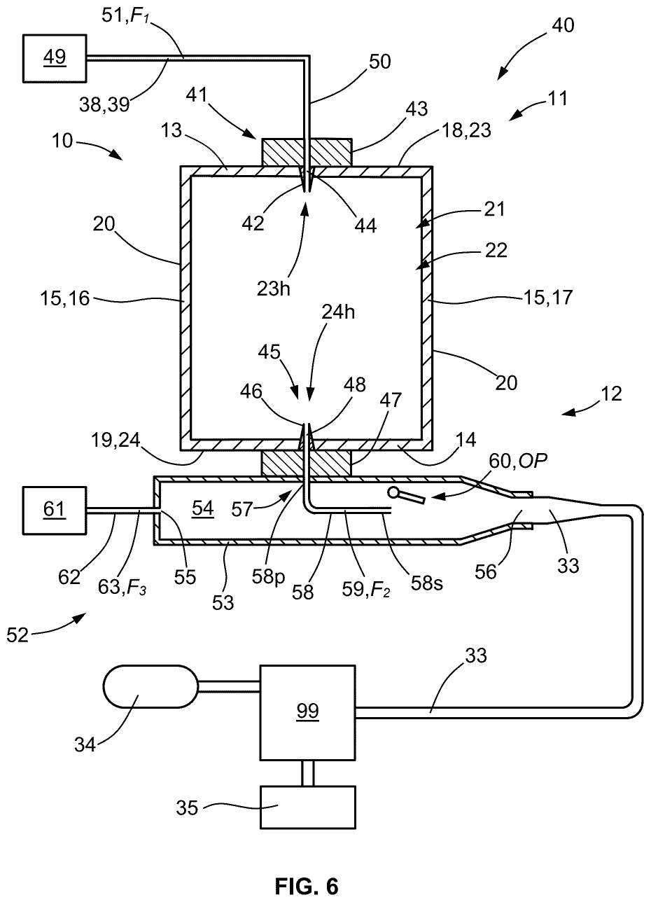

FIGS. 5-6 show exploded and assembled views, respectively, of a system 40 for rapid evacuation of fluid components 33 from a battery cell 10. The system 40 includes the aforementioned first and second puncturing elements, 41, 45, along with respective first and second pressure sources 49, 61 for urging fluid flows F₁, F₃ through each of the puncturing elements, 41, 45, as well as an evacuation manifold 52 connected with the second puncturing element 45.

As shown in FIGS. 5-6, the first puncturing element 41 is configured for interfacing with and puncturing the first surface 23 of the battery cell 10 to form a first hole 23h through the first surface 23, and also through the top wall 13. Similarly, the second puncturing element 45 is configured for interfacing with and puncturing the second surface 24 of the battery cell 10 to form a second hole 24h through the second surface 24, and also through the bottom wall 14.

Note that as used herein, the term “puncture” may include the terms pierce, puncture, cut, slice, open, punch through, ingress into, and the like. Various types and configurations of puncturing or cutting devices may be used as part of the first and second puncturing elements 41, 45 to make the respective first and second holes 23h, 24h. As used herein, the term “hole” may include the terms cut, slit, hole, intrusion, and the like.

The first puncturing element 41 may optionally include a first tip 42 mounted on a first mount 43 or carrier; likewise, the second puncturing element 45 may optionally include a second tip 46 mounted on a second mount 47 or carrier. For example, each of the first and second tips 42, 46 may be shaped as a cone or a conical frustum, with a relatively pointed tip end suitable for piercing through the walls of the battery cell 10 at the first and second surfaces 23, 24. It may be noted that some battery cells 10 may include filling ports through which electrolyte may be poured into the battery cell 10. After filling, these ports may be sealed over with a layer of metal foil that is thinner than the battery cell walls, making these locations ideal first and second surfaces 23, 24 through which the first and second holes 23h, 24h may be formed.

Optionally, a first seal 90 may be carried by the first puncturing element 41 (e.g., on the first mount 43 around the first tip 42), with the first seal 90 being configured for sealing against the first surface 23 so as to prevent leakage between the first puncturing element 41 and the first surface 23 when the first puncturing element 41 punctures the first surface 23. Similarly, a second seal 91 may be carried by the second puncturing element 45 (e.g., on the second mount 47 around the second tip 46), with the second seal 91 being configured for sealing against the second surface 24 so as to prevent leakage between the second puncturing element 45 and the second surface 24 when the second puncturing element 45 punctures the second surface 24.

A first channel 44 extends through the first puncturing element 41, and a second channel 48 extends through the second puncturing element 45. For example, the first channel 44 may extend through the first mount 43 and the first tip 42, and the second channel 48 may extend through the second mount 47 and the second tip 46.

A first pressure source 49 is placed in fluid communication with the first channel 44 via a first conduit 50. The first conduit 50 has a first conduit lumen 51 running therethrough, which is placed in fluid communication with the first channel 44 when the first conduit 50 is sealably connected with the first puncturing element 41. The first pressure source 49 is configured to exert a liquid and/or gaseous fluid pressure so as to cause a first fluid flow F₁ through the first conduit 50 and the first channel 44. For example, the fluid pressure exerted by the first pressure source 49 may be from a pressurized gas, such as an inert gas 38 (e.g., argon, xenon) or a non-reactive gas 39 that is not reactive with the fluid components 33 or with any of the internal components 22 of the battery cell 10 (e.g., nitrogen). Additionally or alternatively, the fluid pressure exerted by the first pressure source 49 may be from a pressurized liquid, such as a flushing fluid like dimethyl carbonate.

With the first and second puncturing elements 41, 45 interfacing with the first and second surfaces 23, 24 and puncturing the first and second holes 23h, 24h, and with the first pressure source 49 providing the first fluid flow F₁ through the first conduit 50 and the first channel 44, the first fluid flow F₁ urges the fluid components 33 that are within the interior 21 of the battery cell 10 to flow out through the second hole 24h.

In order to assist in urging the fluid components 33 to be evacuated through the second hole 24h, an evacuation manifold 52 is provided which provides suction to the second hole 24h. The evacuation manifold 52 has a housing 53 enclosing a plenum 54, a manifold inlet 55 and a manifold outlet 56 each formed in the housing 53 and in fluid communication with the plenum 54, and a through-hole 57 formed in the housing 53 between the manifold inlet 55 and the manifold outlet 56. A downstream direction is defined within the plenum 54 as a direction of flow that proceeds from the manifold inlet 55 to the manifold outlet 56, which appears as a left-to-right flow as viewed in FIGS. 5-8. Thus, the through-hole 57 is situated downstream of the manifold inlet 55, and the manifold outlet 56 is situated downstream of both the manifold inlet 55 and the through-hole 57.

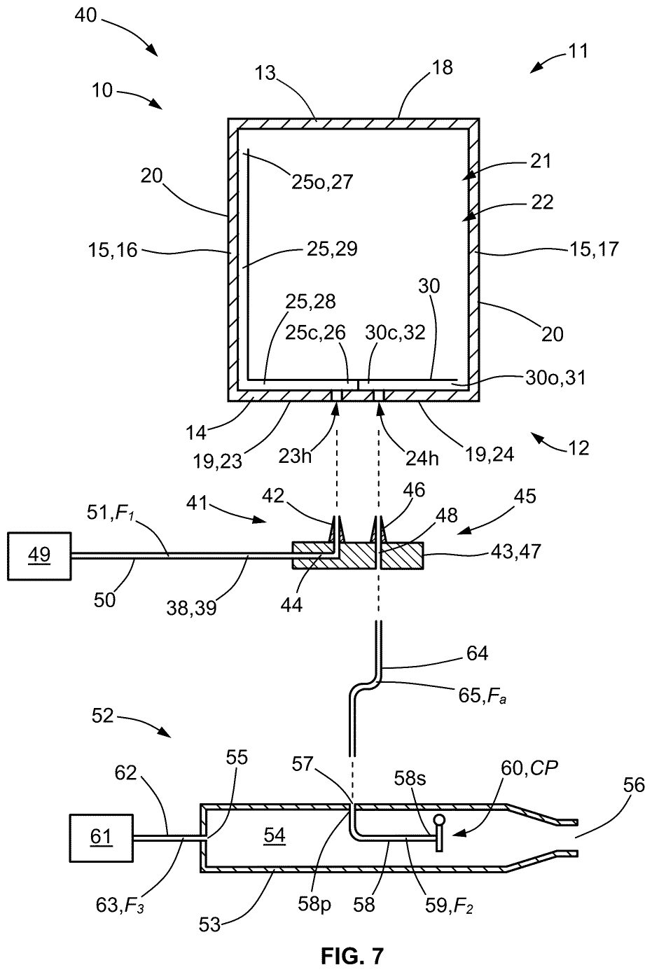

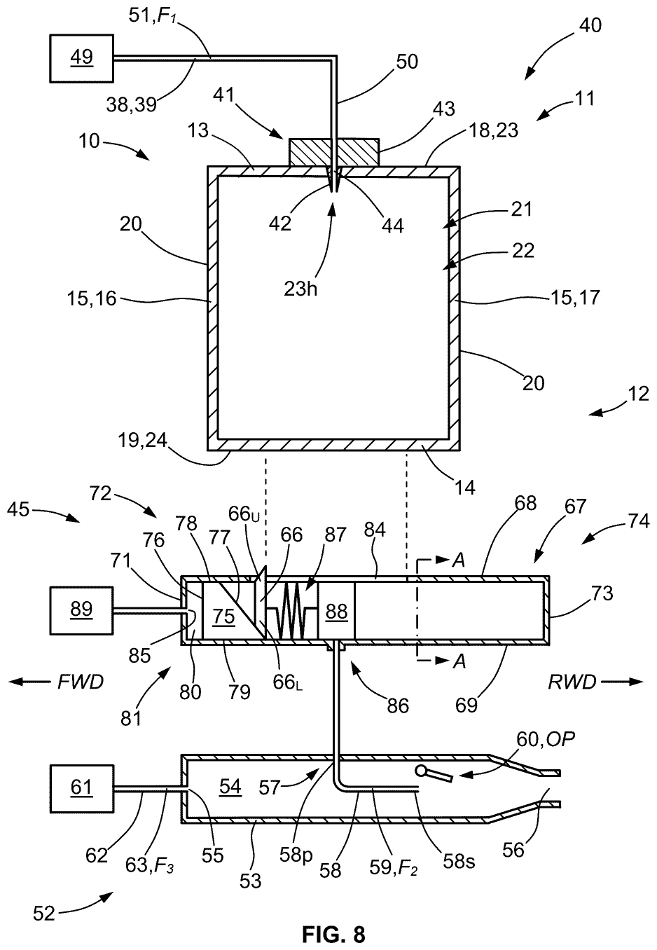

A second conduit 58 is disposed within the evacuation manifold 52, with a primary end 58p of the second conduit 58 placed in fluid communication with the through-hole 57 and a secondary end 58s of the second conduit 58 terminating within the plenum 54 downstream of the through-hole 57 and the primary end 58p. A second conduit lumen 59 runs within the second conduit 58 between the primary and secondary ends 58p, 58s. Additionally, a one-way valve 60 is disposed adjacent the secondary end 58s of the second conduit 58 and is configured to move between a closed position CP which prevents flow through the second conduit 58 (as shown in FIGS. 5 and 7) and an open position OP which permits flow through the second conduit 58 (as shown in FIGS. 6 and 8). For example, the one-way-valve 60 may be a spring-loaded check valve which can pivot up and away from the secondary end 58s and into the open position OP when there is downstream fluid flow within the plenum 54, and which can pivot downward and against the secondary end 58s into the closed position CP when there is no downstream fluid flow within the plenum 54.

A second pressure source 61 is placed in fluid communication with the manifold inlet 55 via a third conduit 62 having a third conduit lumen 63. The second pressure source 61 is configured to cause a second fluid flow F₂ through the third conduit 62 and the manifold inlet 55, downstream through the plenum 54 from the manifold inlet 55 to the manifold outlet 56, and out the manifold outlet 56. This downstream second fluid flow F₂ may be caused by the second pressure source 61 releasing a pressurized liquid or gas through the third conduit 62 and through the plenum 54; this urges the one-way valve 60 to transition from the closed position CP to the open position OP, and also creates a venturi effect through the plenum 54, thereby exerting a suction on the open second conduit 58 which urges the flow of fluid components 33 through the second hole 24h, through the second channel 48 and optional auxiliary conduit 64, through the second conduit 58, and out the manifold outlet 56.

The evacuation manifold 52 is configured to interface with the second puncturing element 45 such that the through-hole 57 is aligned or placed in fluid communication with the second channel 48 that is within the second puncturing element 45. This may be accomplished by utilizing an auxiliary conduit 64 between the second puncturing element 45 and the evacuation manifold 52, as illustrated in FIG. 5, or by placing the second puncturing element 45 and the evacuation manifold 52 in direct contact with each other, as illustrated in FIG. 6. The auxiliary conduit 64 may have an auxiliary conduit lumen 65 therein for accommodating an auxiliary fluid flow Fₐ therethrough.

As shown in FIG. 6, the system 40 may further include an accumulator/separator 99 for receiving the fluid components 33 from the manifold outlet 56 and for separating the fluid components 33 into gas components 34 and non-gas components 35. Optionally, the accumulator/separator 99 may also be configured to dry out or dehumidify at least some of the fluid components 33 during and/or after separation of the fluid components 33 into gas components 34 and non-gas components 35.

The system 40 may further include an inlet valve 92 disposed in or along the first fluid flow F₁. For example, as illustrated in FIG. 5, the inlet valve 92 may be located in-line with the first conduit 50, while in other configurations an inlet valve 92 may be situated within the first puncturing element 41, such as within the first mount 43. The inlet valve 92 may be configured for at least one of dynamically variable flow and pulsing flow, where dynamically variable flow provides continuous flow which fluctuates between or among two or more different pressures (e.g., varying in a sinusoidal manner between a high pressure and a low pressure), while pulsing flow provides intermittent or on-and-off flow. The surge in flow from a lower pressure to a higher pressure in dynamically variable flow, and/or the pulsing or “hammering” effect of pulsing flow, may help to dislodge any loose or loosenable particles from within the interior 21 of the battery cell 10.

FIG. 7 shows an alternative embodiment of the system 40, which cooperates with an alternative battery cell 10 such as the one shown in FIG. 3. In this arrangement, the first and second surfaces 23, 24 may be on a bottom wall 14 of the battery cell 10, with the battery cell 10 including a first internal channel 25 and a second internal channel 30. As illustrated in the drawings, the first internal channel 25 extends horizontally outward in a first leg 28 along the bottom wall 14, from a first closed end 25c at a starting point 26 that is near the first surface 23 to the first side wall 16 of the battery cell 10, and in a second leg 29 extending vertically upward along the first side wall 16 to a first open end 25o at a terminating point 27 that is near the top wall 13 of the battery cell 10. The second internal channel 30 extends along the bottom wall 14 from a second open end 30o at a beginning point 31 that is near the second side wall 17 (generally opposite the first side wall 16) to a second closed end 30c at an ending point 32 that is inward of the second side wall 17. Note that in FIG. 3, the first and second internal channels 25, 30 are near each other but spaced apart from each other, whereas in FIG. 7, the first and second internal channels 25, 30 are abutting each other. In either case, the starting point 26 of the first internal channel 25 and the beginning point 31 of the second internal channel 30 are situated such that when the first and second holes 23h, 24h are punctured through the bottom wall 14, the first hole 23h is placed in fluid communication with the first internal channel 25 and the second hole 24h is placed in fluid communication with the second internal channel 30.

In FIG. 7, note that the first and second puncturing elements 41, 45 are combined or ganged together into a single unit, with separate first and second tips 42, 46 carried on a single combined mount 43, 47. Such a combined arrangement of the first and second puncturing elements 41, 45 may be especially convenient when used with an alternative battery cell 10 having first and second internal channels 25, 30 arranged within the interior 21 along the bottom wall 14. Regardless of whether the first and second puncturing elements 41, 45 are combined together into a single unit as shown in FIG. 7, or are separated into two separate units, fluid flow is injected into the battery cell 10 via the first hole 23h and is sucked out of the battery cell 10 via second hole 24h. For example, in the particular case of FIG. 7, the first pressure source 49 injects a fluid though the first hole 23h, which then travels into the first internal channel 25, out the first open end 25o of the first internal channel 25 at the terminating point 27, through the interior 21 of the battery cell 10 from the top portion 11 to the bottom portion 12, into the second open end 30o of the second interior channel 30 and then through the second hole 24h; meanwhile, fluid is also sucked out of the battery cell 10 through the second hole 24h by the combined action of the second pressure source 61 and the evacuation manifold 52.

FIGS. 8-13 show various views of another alternative embodiment of the system 40. Here, the battery cell 10 has the same form as the battery cell 10 shown in FIGS. 1-2 and 5-6, but the second puncturing element 45 has an alternative form that is different from the forms previously shown. As illustrated in FIG. 8, the second puncturing element 45 includes an elongated tube 67 having an upper wall 68, a lower wall 69, a first end wall 71 at a first end 72 of the tube 67 defining a forward direction FWD, and a second end wall 73 at a second end 74 of the tube 67 defining a rearward direction RWD. The tube 67 may be generally sealed except for a tube inlet 85 formed on the first end 72 (e.g., in the first end wall 71 or in a forward portion of the upper or lower wall 68, 69), a tube outlet 86 formed in the lower wall 69, and a slot 84 formed in the upper wall 68.

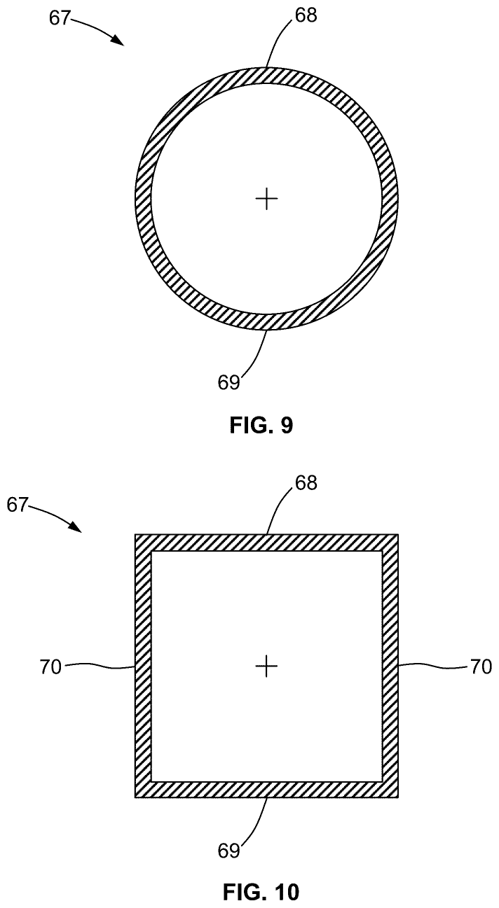

FIGS. 9-10 show schematic cross-sectional views of the tube 67 as viewed along section A-A of FIG. 8, and illustrating circular and rectangular tube shapes, respectively. In FIG. 9 the circular cross-sectional shape shows that the tube 67 has a top wall 68 and a bottom wall 69, while in FIG. 10, the rectangular cross-sectional shape shows that the tube 67 has a top wall 68, a bottom wall 69, and two opposing side walls 70. With regard to FIG. 9, while side walls are not explicitly labeled in the drawing, the regions on the left and right sides of the drawing where the top and bottom walls 68, 69 meet may be considered as side walls. Note that while only circular and rectangular tube shapes are shown, other cross-sectional shapes are possible as well, such as hexagonal, etc.

Returning now to FIG. 8, it may be seen that a wedge 75 is sealably and slidably disposed within the tube 67. The wedge 75 has a top wedge surface 78 in sliding contact with the inner surface of the upper wall 68, a bottom wedge surface 79 in sliding contact with the inner surface of the lower wall 69, a first wedge surface 76 generally facing the forward direction FWD, and an upwardly sloping ramp surface 77 generally facing the rearward direction RWD. The wedge 75 is slidable within the tube 67 between a forward position 81 and a rearward position 82, with a middle position 83 being between the forward and rearward positions 81, 82. A tube chamber 80 is defined within the tube 67 between the first end wall 71 and the first wedge surface 76. The volume of the tube chamber 80 increases as the wedge 75 is moved from the forward position to the middle position 83, and increases even further as the wedge 75 is moved from the middle position 83 to the rearward position 82.

The second puncturing element 45 includes a generally vertically oriented blade 66 having an upper blade portion 66_{U} and a lower blade portion 66_{L}. The lower blade portion 66_{L} is shaped and arranged so as to be supported upon the ramp surface 77, and to be upwardly slidable along the ramp surface 77. Additionally, a piston 88 is sealably and slidably disposed within the tube 67 and positioned rearward of the wedge 75, with a biasing member 87 being disposed between the blade 66 and the piston 88. Further, a third pressure source 89 is presented in fluid communication with the tube inlet 85.

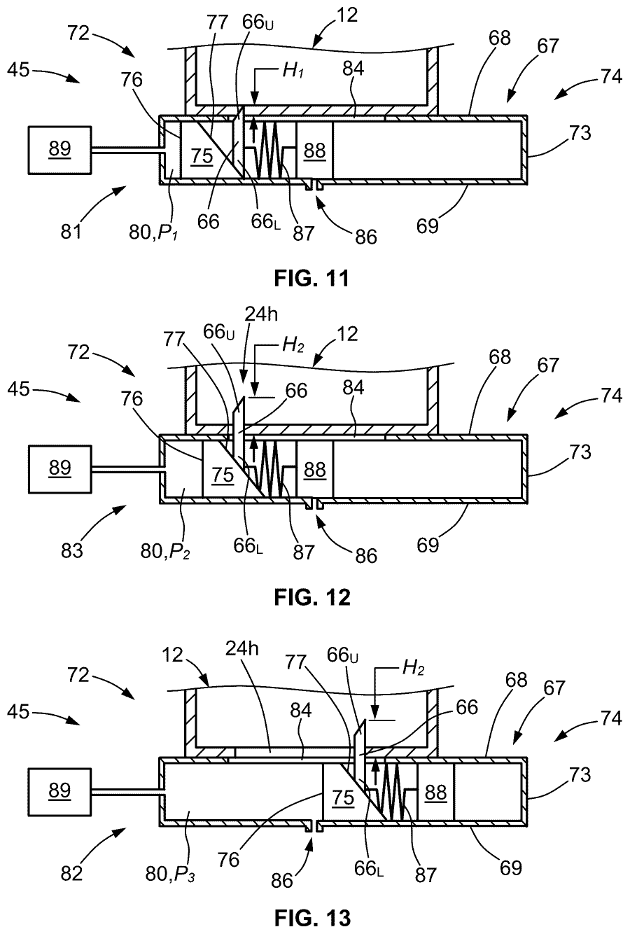

FIGS. 11-13 show schematic cross-sectional views of the tubular second puncturing element 45, with the wedge 75 being shown in the forward position 81, the middle position 83, and the rearward position 82, respectively.

In FIG. 11, the wedge 75 is positioned in the forward position 81, and a first pressure P₁ is present in the tube chamber 80. This first pressure P₁ may be normal atmospheric pressure, or it may be slightly higher or lower than normal atmospheric pressure. The first pressure P₁ may be produced by the third pressure source 89. In this first position 81, the first wedge surface 76 is disposed forward of the tube outlet 86, such that no fluid flow is able to exit through the tube outlet 86. Optionally, as shown in the drawings, the piston 88 may be positioned so as to seal off the tube outlet 86 to prevent fluid leakage therethrough. Also in this first position 81, the lower blade portion 66_{L} rests upon a lower portion of the ramp surface 77, with the upper blade portion 66_{U} extending to a first height H₁ above or with respect to the slot 84. If the upper blade portion 66_{U} is positioned so as to be even with the slot 84, then the first height H₁ would be zero, and if the upper blade portion 66_{U} is positioned so as to be lower than the slot 84, then the first height H₁ would be negative. In this first position 81, the blade 66 may be considered to be in a retracted position.

In FIG. 12, the wedge 75 is positioned in the middle position 83. The wedge 75 is moved from the forward position 81 to the middle position 83 by increasing the pressure in the tube chamber 80 to a second pressure P₂ that is higher than the first pressure P₁, such as by the third pressure source 89. The wedge 75 and the piston 88 may be shaped and dimensioned, made out of appropriate materials, and provided with respective sliding fits with respect to the inner surfaces of the upper, lower and side walls 68, 69, 70 of the tube 67, such that the piston 88 resists sliding movement more than the wedge 75 does. Thus, increasing pressure in the tube chamber 80 from the first pressure P₁ to the second pressure P₂ causes the wedge 75 to move rearward, while the piston 88 remains substantially unmoved, thereby compressing the biasing member 87 between the wedge 75 and the piston 88. With the blade 66 positioned with the lower blade portion 66_{L} resting on the upwardly sloping ramp surface 77, and with the upper blade portion 66_{U} constrained to remain upright (such as by extending through and resting against the sides of the slot 84), the rearward movement of the wedge 75 causes the lower blade portion 66_{L} to slide diagonally upward along the ramp surface 77 and the upper blade portion 66_{U} to extend to a second height H₂ above the slot 84 that is greater than the first height H₁. Note that is this second position 83, the first wedge surface 76 remains forward of the tube outlet 86.

In FIG. 13, the wedge 75 is positioned in the rearward position 82. The wedge 75 is moved from the middle position 83 to the rearward position 82 by increasing the pressure in the tube chamber 80 to a third pressure P₃ that is higher than the second pressure P₂. This pressure increase causes both the wedge 75 and the piston 88 to be moved rearward while the biasing member 87 remains compressed. During this move from the middle position 83 to the rearward position 82, the upper blade portion 66_{U} maintains the second height H₂. When the wedge 75 is moved into the rearward position 82, the first wedge surface 76 is disposed rearward of the tube outlet 86, so as to allow fluid flow therethrough.

At least one of the first puncturing element 41 and the second puncturing element 45 may be carried by or incorporated into the evacuation manifold 52.

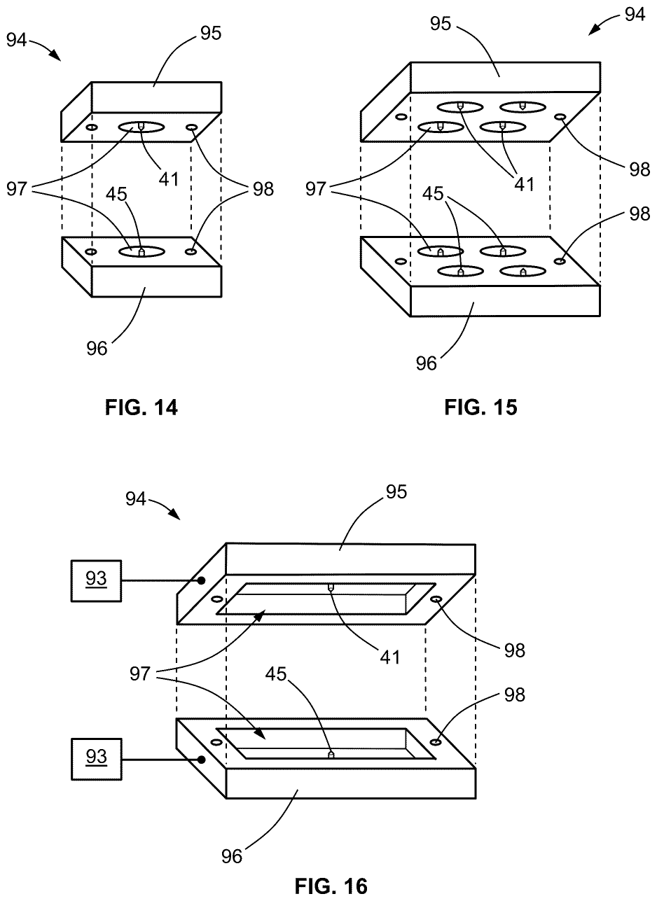

FIGS. 14-16 show first, second and third configurations, respectively, of a holding frame 94 having opposed top and bottom platens 95, 96. The first configuration of FIG. 14 is configured to interface with a single cylindrical battery cell 10 (not shown), the second configuration of FIG. 15 is configured to interface with four cylindrical battery cells 10 (not shown), and the third configuration of FIG. 16 is configured to interface with a single prismatic battery cell 10 (not shown).

The top platen 95 is configured to interface with the top portion(s) 11 of one or more battery cells 10, while the bottom platen 96 is configured to interface with the bottom portion(s) 12 of the battery cells 10, such as by utilizing recesses 97 formed in the top and bottom platens 95, 96. The top and bottom platens 95, 96 are configured to cooperate together for holding and securing the battery cell 10 against movement, such as by utilizing vertically oriented linear guide rails to guide the top and bottom platens 95, 96, along with a hydraulically operated platen press. The first puncturing element(s) 41 may be carried by or incorporated into the top platen 95, and the second puncturing element(s) 45 may be carried by or incorporated into the bottom platen 96. Various alignment features 98 may be provided in the top and bottom platens 95, 96, such as holes, pins, telescoping shafts, etc. A vibrating member 93 configured for vibrating the battery cell 10 may be carried by or incorporated into one or both of the top and bottom platens 95, 96.

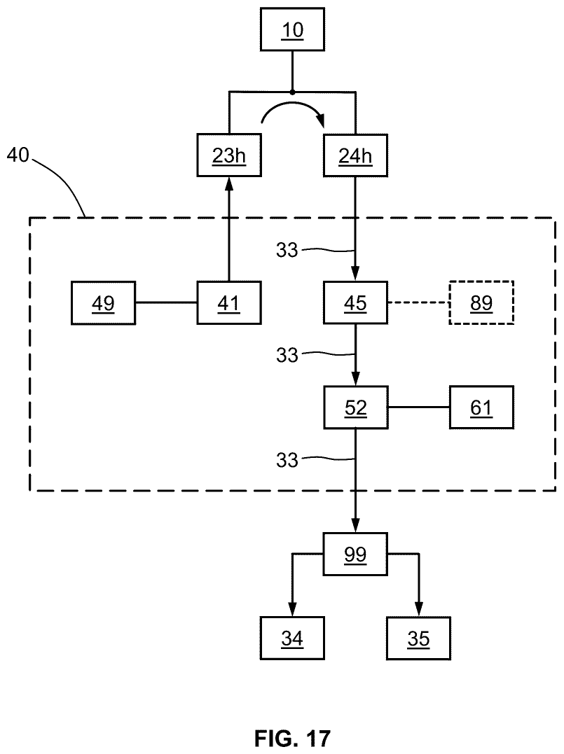

FIG. 17 shows a block diagram of the system 40. As shown in the drawing, the system 40 includes: (i) a first puncturing element 41 connected with a first pressure source 49 for supplying a fluid flow into a first hole 23h in a battery cell 10; (ii) a second puncturing element 45 (optionally connected with a third pressure source 89) for receiving or suctioning fluid components 33 from the battery cell 10 through a second hole 24h in the battery cell 10; (iii) an evacuation manifold 52 for exerting suction on the battery cell 10 through the second puncturing element 45 and for rapidly evacuating the fluid components 33 from the battery cell 10. An optional accumulator/separator 99 may receive the fluid components 33 from the evacuation manifold 52 and may separate the fluid components 33 into gas components 34 and non-gas components 35.

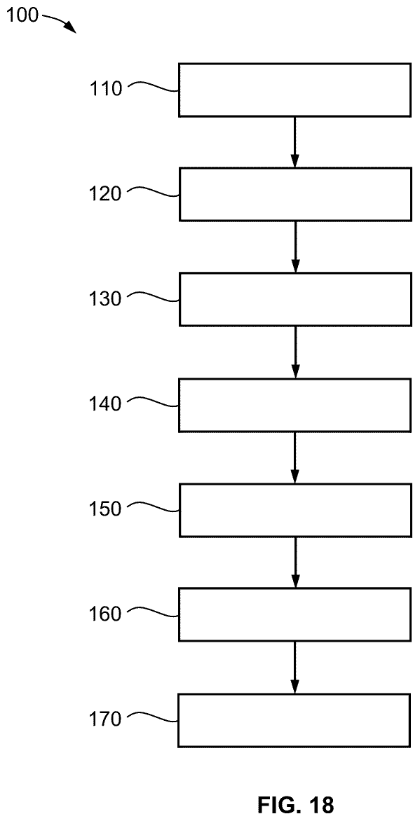

FIG. 18 shows a flowchart for a method 100 for rapid evacuation of fluid components 33 from a battery cell 10. This method 100 may be carried out using the system 40 described above.

At block 110, a first surface 23 of the battery cell 10 is punctured with a first puncturing element 41 having a first channel 44 extending therethrough, so as to form a first hole 23h through the first surface 23.

At block 120, a second surface 24 of the battery cell 10 is punctured with a second puncturing element 45 having a second channel 48 extending therethrough, so as to form a second hole 24h through the second surface 24.

At block 130, an evacuation manifold 52 having a housing 53 with a through-hole 57 formed therein is interfaced or mated with the second puncturing element 45, such that the through-hole 57 is placed in fluid communication with the second channel 48. Here, the housing 53 encloses a plenum 54, and the evacuation manifold 52 has a manifold inlet 55 and a manifold outlet 56 formed in the housing 53 and in fluid communication with the plenum 54. A downstream direction is defined from the manifold inlet 55 to the manifold outlet 56, with the through-hole 57 being located between the manifold inlet 55 and the manifold outlet 56. The evacuation manifold 52 includes a second conduit 58 having a primary end 58p in fluid communication with the through-hole 57 and a secondary end 58s terminating within the plenum 54 downstream of the primary end 58p. The evacuation manifold 52 also includes a one-way valve 60 disposed adjacent the secondary end 58s of the second conduit 58 and configured to move between a closed position CP (which prevents flow through the second conduit 58) and an open position OP (which permits flow through the second conduit 58).

At block 140, a first fluid flow F₁ through the first channel 44 is caused by using a first pressure source 49 having a first conduit 50 in fluid communication with the first channel 44.

And at block 150, a second fluid flow F₂ through the plenum 54 and out the manifold outlet 56 is caused by using a second pressure source 61 having a third conduit 62 in fluid communication with the manifold inlet 55.

In this method 100, the first and second fluid flows F₁, F₂ cause the fluid components 33 within the battery cell 10 to flow through the second hole 24h, the second channel 48 and the second conduit 58 and out the manifold outlet 56.

Optionally, the method 100 may further include, at block 160, vibrating the battery cell 10 by using a vibrating member 93 that is carried by or incorporated into at least one of a top platen 95 and a bottom platen 96 of a holding frame 94. Here, the top platen 95 is configured to interface with a top portion 11 of the battery cell 10 and the bottom platen 96 is configured to interface with a bottom portion 12 of the battery cell 10, with the top and bottom platens 95, 96 being configured to cooperate together for securing the battery cell 10 against movement.

The method 100 may further include, at block 170, flushing the battery cell 10 with a liquid that is not reactive with the fluid components 33 or with any internal components 22 of the battery cell 10. The flushing of the battery cell 10 may include passing the liquid through the first puncturing element 41, the battery cell 10, the second puncturing element 45 and the evacuation manifold 52. As noted above, the liquid used to flush out the battery cell 10 may include dimethyl carbonate or other suitable fluids.

The various configurations and embodiments of the system 40 and method 100 presented herein may be implemented in multiple different applications and use cases, including use with electric or hybrid automotive vehicles. For example, the system 40 and method 100 may be implemented on-board such vehicles, or they may be implemented off-board such vehicles, or some portions may be implemented on-board while other portions may be implemented off-board.

As one having skill in the relevant art will appreciate, the system 40 and method 100 of the present disclosure may be presented or arranged in a variety of different configurations and embodiments.

According to one embodiment, a system 40 for rapid evacuation of fluid components 33 from a battery cell 10 includes: (i) a first puncturing element 41 configured for interfacing with and puncturing a first surface 23 of the battery cell 10 to form a first hole 23h through the first surface 23, and having a first channel 44 extending through the first puncturing element 41; (ii) a second puncturing element 45 configured for interfacing with and puncturing a second surface 24 of the battery cell 10 to form a second hole 24h through the second surface 24, and having a second channel 48 extending through the second puncturing element 45; (iii) a first pressure source 49 in fluid communication with the first channel 44 via a first conduit 50 and configured to cause a first fluid flow F₁ through the first conduit 50 and the first channel 44; (iv) an evacuation manifold 52 having a housing 53 enclosing a plenum 54, a manifold inlet 55 and a manifold outlet 56 each formed in the housing 53 and in fluid communication with the plenum 54 with a downstream direction defined from the manifold inlet 55 to the manifold outlet 56, a through-hole 57 formed in the housing 53 between the manifold inlet 55 and the manifold outlet 56, a second conduit 58 having a primary end 58p in fluid communication with the through-hole 57 and a secondary end 58s terminating within the plenum 54 downstream of the primary end 58p, and a one-way valve 60 disposed adjacent the secondary end 58s of the second conduit 58 and configured to move between a closed position CP which prevents flow through the second conduit 58 and an open position OP which permits flow through the second conduit 58; and (v) a second pressure source 61 in fluid communication with the manifold inlet 55 via a third conduit 62 and configured to cause a second fluid flow F₂ through the third conduit 62 and the plenum 54 and out the manifold outlet 56. The evacuation manifold 52 is configured to interface with the second puncturing element 45 such that the through-hole 57 is placed in fluid communication with the second channel 48, and the first and second fluid flows F₁, F₂ cause the fluid components 33 to flow through the second hole 24h, the second channel 48 and the second conduit 58 and out the manifold outlet 56.

The battery cell 10 may be a prismatic battery cell or a cylindrical battery cell.

The first surface 23 may be a top surface 18 of the battery cell 10 and the second surface 24 may be a bottom surface 19 of the battery cell 10. Alternatively, the first and second surfaces 23, 24 may be on a bottom surface 19 of the battery cell 10.

At least one of the first puncturing element 41 and the second puncturing element 45 may be carried by or incorporated into the evacuation manifold 52.

The system 40 may further include a holding frame 94 having a top platen 95 configured to interface with a top portion 11 of the battery cell 10 and a bottom platen 96 configured to interface with a bottom portion 12 of the battery cell 10, wherein the top and bottom platens 95, 96 are configured to cooperate together for securing the battery cell 10 against movement.

The first puncturing element 41 may be carried by or incorporated into the top platen 95, and the second puncturing element 45 may be carried by or incorporated into the bottom platen 96.

The system 40 may further include a vibrating member 93 carried by or incorporated into at least one of the top platen 95 and the bottom platen 96 and configured for vibrating the battery cell 10.

The system 40 may further include a first seal 90 carried by the first puncturing element 41 and configured for sealing against the first surface 23 so as to prevent leakage between the first puncturing element 41 and the first surface 23 when the first puncturing element 41 punctures the first surface 23, and a second seal 91 carried by the second puncturing element 45 and configured for sealing against the second surface 24 so as to prevent leakage between the second puncturing element 45 and the second surface 24 when the second puncturing element 45 punctures the second surface 24.

The system 40 may further include an accumulator/separator 99 for receiving the fluid components 33 from the manifold outlet 56 and for separating the fluid components 33 into gas components 34 and non-gas components 35.

The first fluid flow F₁ from the first pressure source 49 may include at least one of an inert gas 38 and a non-reactive gas 39 that is not reactive with the fluid components 33 or with any internal components 22 of the battery cell 10.

The system 40 may further include an inlet valve 92 disposed in the first fluid flow F₁ and configured for at least one of dynamically variable flow and pulsing flow.

The first and second surfaces 23, 24 may be on a bottom wall 14 of the battery cell 10, wherein the battery cell 10 includes a first internal channel 25 extending in a first leg 28 along the bottom wall 14 from a first closed end 25c at a starting point 26 adjacent the first surface 23 to a first side wall 16 of the battery cell 10 and in a second leg 29 upward along the first side wall 16 to a first open end 25o at a terminating point 27 adjacent a top wall 13 of the battery cell 10, and wherein the first hole 23h is in fluid communication with the first internal channel 25.

The battery cell 10 may include a second internal channel 30 extending along the bottom wall 14 from a second open end 30o at a beginning point 31 adjacent a second side wall 17 generally opposite the first side wall 16 to a second closed end 30c at an ending point 32 that is inward of the second side wall 17, and the second hole 24h may be in fluid communication with the second internal channel 30.

The second puncturing element 45 may include: (a) a tube 67 having an upper wall 68, a lower wall 69, a first end wall 71 at a first end 72 of the tube 67 defining a forward direction FWD, and a second end wall 73 at a second end 74 of the tube 67 defining a rearward direction RWD, wherein the tube 67 is generally sealed except for a tube inlet 85 formed on the first end 72, a tube outlet 86 formed in the lower wall 69 and a slot 84 formed in the upper wall 68; (b) a wedge 75 sealably and slidably disposed within the tube 67 between a forward position 81 and a rearward position 82 with a middle position 83 between the forward and rearward positions 81, 82, the wedge 75 having a first wedge surface 76 generally facing the forward direction FWD and an upwardly sloping ramp surface 77 generally facing the rearward direction RWD, wherein a tube chamber 80 is defined within the tube 67 between the first end wall 71and the first wedge surface 76; (c) a generally vertical blade 66 having an upper blade portion 66_{U} and a lower blade portion 66_{L}, wherein the lower blade portion 66_{L} is supported upon and is upwardly slidable along the ramp surface 77; (d) a piston 88 sealably and slidably disposed within the tube 67 and positioned rearward of the wedge 75; (e) a biasing member 87 disposed between the blade 66 and the piston 88; and (f) a third pressure source 89 in fluid communication with the tube inlet 85.

In the forward position 81, a first pressure P₁ may be present in the tube chamber 80, the first wedge surface 76 may be disposed forward of the tube outlet 86 and the upper blade portion 66_{U} may extend to a first height H₁ above the slot 84.

Between the forward position 81 and the middle position 83, a second pressure P₂ that is higher than the first pressure P₁ may be developed in the tube chamber 80 by the third pressure source 89, thereby urging the wedge 75 rearward while the piston 88 remains unmoved and compressing the biasing member 87, thus causing the upper blade portion 66_{U} to extend to a second height H₂ above the slot 84 that is greater than the first height H₁, wherein the first wedge surface 76 remains disposed forward of the tube outlet 86.

Between the middle position 83 and the rearward position 82, a third pressure P₃ that is higher than the second pressure P₂ may be developed in the tube chamber 80 by the third pressure source 89, thereby urging the wedge 75 and the piston 88 rearward while the upper blade portion 66_{U} maintains the second height H₂, until the wedge 75 is urged into the rearward position 82 with the first wedge surface 76 being disposed rearward of the tube outlet 86.

According to another embodiment, a system 40 for rapid evacuation of fluid components 33 from a battery cell 10 includes: (i) a first puncturing element 41 configured for interfacing with and puncturing a first surface 23 of the battery cell 10 to form a first hole 23h through the first surface 23, and having a first channel 44 extending through the first puncturing element 41; (ii) a second puncturing element 45 configured for interfacing with and puncturing a second surface 24 of the battery cell 10 to form a second hole 24h through the second surface 24, and having a second channel 48 extending through the second puncturing element 45; (iii) a first pressure source 49 in fluid communication with the first channel 44 via a first conduit 50 and configured to cause a first fluid flow F₁ through the first conduit 50 and the first channel 44; (iv) an evacuation manifold 52 having a housing 53 enclosing a plenum 54, a manifold inlet 55 and a manifold outlet 56 each formed in the housing 53 and in fluid communication with the plenum 54 with a downstream direction defined from the manifold inlet 55 to the manifold outlet 56, a through-hole 57 formed in the housing 53 between the manifold inlet 55 and the manifold outlet 56, a second conduit 58 having a primary end 58p in fluid communication with the through-hole 57 and a secondary end 58s terminating within the plenum 54 downstream of the primary end 58p, and a one-way valve 60 disposed adjacent the secondary end 58s of the second conduit 58 and configured to move between a closed position CP which prevents flow through the second conduit 58 and an open position OP which permits flow through the second conduit 58; and (v) a second pressure source 61 in fluid communication with the manifold inlet 55 via a third conduit 62 and configured to cause a second fluid flow F₂ through the third conduit 62 and the plenum 54 and out the manifold outlet 56. The second puncturing element 45 includes: (a) a tube 67 having an upper wall 68, a lower wall 69, a first end wall 71 at a first end 72 of the tube 67 defining a forward direction FWD, and a second end wall 73 at a second end 74 of the tube 67 defining a rearward direction RWD, wherein the tube 67 is generally sealed except for a tube inlet 85 formed on the first end 72, a tube outlet 86 formed in the lower wall 69 and a slot 84 formed in the upper wall 68; (b) a wedge 75 sealably and slidably disposed within the tube 67 between a forward position 81 and a rearward position 82 with a middle position 83 between the forward and rearward positions 81, 82, the wedge 75 having a first wedge surface 76 generally facing the forward direction FWD and an upwardly sloping ramp surface 77 generally facing the rearward direction RWD, wherein a tube chamber 80 is defined within the tube 67 between the first end wall 71 and the first wedge surface 76; (c) a generally vertical blade 66 having an upper blade portion 66_{U} and a lower blade portion 66_{L}, wherein the lower blade portion 66_{L} is supported upon and is upwardly slidable along the ramp surface 77; (d) a piston 88 sealably and slidably disposed within the tube 67 and positioned rearward of the wedge 75; (e) a biasing member 87 disposed between the blade 66 and the piston 88; and (f) a third pressure source 89 in fluid communication with the tube inlet 85.

In the forward position 81, a first pressure P₁ is present in the tube chamber 80, the first wedge surface 76 is disposed forward of the tube outlet 86 and the upper blade portion 66_{U} extends to a first height H₁ above the slot 84. Between the forward position 81 and the middle position 83, a second pressure P₂ that is higher than the first pressure P₁ is developed in the tube chamber 80 by the third pressure source 89, thereby urging the wedge 75 rearward while the piston 88 remains unmoved and compressing the biasing member 87, thus causing the upper blade portion 66_{U} to extend to a second height H₂ above the slot 84 that is greater than the first height H₁, wherein the first wedge surface 76 remains disposed forward of the tube outlet 86. And between the middle position 83 and the rearward position 82, a third pressure P₃ that is higher than the second pressure P₂ is developed in the tube chamber 80 by the third pressure source 89, thereby urging the wedge 75 and the piston 88 rearward while the upper blade portion 66_{U} maintains the second height H₂, until the wedge 75 is urged into the rearward position 82 with the first wedge surface 76 being disposed rearward of the tube outlet 86.

In this embodiment, the evacuation manifold 52 is configured to interface with the second puncturing element 45 such that the through-hole 57 is placed in fluid communication with the second channel 48, and the first and second fluid flows F₁, F₂ cause the fluid components 33 to flow through the second hole 24h, the second channel 48 and the second conduit 58 and out the manifold outlet 56.

According to yet another embodiment, a method 100 for rapidly evacuating fluid components 33 from a battery cell 10 includes: (i) puncturing a first surface 23 of the battery cell 10 with a first puncturing element 41 having a first channel 44 extending therethrough so as to form a first hole 23h through the first surface 23; (ii) puncturing a second surface 24 of the battery cell 10 with a second puncturing element 45 having a second channel 48 extending therethrough so as to form a second hole 24 h through the second surface 24; (iii) interfacing an evacuation manifold 52 having a housing 53 with a through-hole 57 formed therein with the second puncturing element 45 such that the through-hole 57 is placed in fluid communication with the second channel 48, wherein the housing 53 encloses a plenum 54 and the evacuation manifold 52 has a manifold inlet 55 and a manifold outlet 56 each formed in the housing 53 and in fluid communication with the plenum 54 with a downstream direction defined from the manifold inlet 55 to the manifold outlet 56 and with the through-hole 57 being disposed between the manifold inlet 55 and the manifold outlet 56, a second conduit 58 having a primary end 58p in fluid communication with the through-hole 57 and a secondary end 58s terminating within the plenum 54 downstream of the primary end, and a one-way valve 60 disposed adjacent the secondary end 58s of the second conduit 58 and configured to move between a closed position CP which prevents flow through the second conduit 58 and an open position OP which permits flow through the second conduit 58; (iv) causing a first fluid flow F₁ through the first channel 44 by using a first pressure source 49 having a first conduit 50 in fluid communication with the first channel 44; and (v) causing a second fluid flow F₂ through the plenum 54 and out the manifold outlet 56 by using a second pressure source 61 having a third conduit 62 in fluid communication with the manifold inlet 55. In this method 100, the first and second fluid flows F₁, F₂ cause the fluid components 33 to flow through the second hole 24h, the second channel 48 and the second conduit 58 and out the manifold outlet 56.

The method 100 may further include flushing the battery cell 10 with a liquid that is not reactive with the fluid components 33 or with any internal components 22 of the battery cell 10. The flushing of the battery cell 10 may include passing the liquid through the first puncturing element 41, the battery cell 10, the second puncturing element 45 and the evacuation manifold 52.

The method 100 may further include vibrating the battery cell 10 by using a vibrating member 93 that is carried by or incorporated into at least one of a top platen 95 and a bottom platen 96 of a holding frame 94, wherein the top platen 95 is configured to interface with a top portion 11 of the battery cell 10 and the bottom platen 96 is configured to interface with a bottom portion 12 of the battery cell 10, wherein the top and bottom platens 95, 96 are configured to cooperate together for securing the battery cell 10 against movement.

While various steps of the method 100 have been described as being separate blocks, and various functions of the system 40 have been described as being separate modules or elements, it may be noted that two or more steps may be combined into fewer blocks, and two or more functions may be combined into fewer modules or elements. Similarly, some steps described as a single block may be separated into two or more blocks, and some functions described as a single module or element may be separated into two or more modules or elements. Additionally, the order of the steps or blocks described herein may be rearranged in one or more different orders, and the arrangement of the functions, modules and elements may be rearranged into one or more different arrangements.

(As used herein, a “module” may include hardware and/or software, including executable instructions, for receiving one or more inputs, processing the one or more inputs, and providing one or more corresponding outputs. Also note that at some points throughout the present disclosure, reference may be made to a singular input, output, element, etc., while at other points reference may be made to plural/multiple inputs, outputs, elements, etc. Thus, weight should not be given to whether the input(s), output(s), element(s), etc. are used in the singular or plural form at any particular point in the present disclosure, as the singular and plural uses of such words should be viewed as being interchangeable, unless the specific context dictates otherwise.)

The above description is intended to be illustrative, and not restrictive. While the dimensions and types of materials described herein are intended to be illustrative, they are by no means limiting and are exemplary embodiments. In the following claims, use of the terms “first”, “second”, “top”, “bottom”, etc. are used merely as labels, and are not intended to impose numerical or positional requirements on their objects. For purposes of the present description, unless specifically disclaimed, use of the singular includes the plural and vice versa. Additionally, the phrase “at least one of A and B” and the phrase “A and/or B” should each be understood to mean “only A, only B, or both A and B”.

Moreover, unless explicitly stated to the contrary, the words “including”, “containing”, “comprising”, “having” and the like shall mean “including without limitation”, and embodiments including one or more elements having a particular property may include one or more additional of such elements that do not have that property. And when broadly descriptive adverbs such as “substantially” and “generally” are used herein to modify a word or phrase, these adverbs mean “mostly”, “mainly”, “for the most part”, “to a significant extent”, “to a large degree” and/or “at least 51 to 99% out of a possible extent of 100%”, and do not necessarily mean “perfectly”, “completely”, “strictly”, “entirely” or “100%”. Additionally, words of approximation such as “about”, “almost”, “approximately” or the like may be used herein in the sense of “at, near, or nearly at”, or “within 0-5% of”, or “within acceptable manufacturing or production tolerances”, or logical combinations thereof. Furthermore, the word “proximate” may be used herein to describe the location of an object or portion thereof with respect to another object or portion thereof, and/or to describe the positional relationship of two objects or their respective portions thereof with respect to each other, and may mean “near”, “adjacent”, “close to”, “close by”, “at” or the like.

As used herein, a component or module that is “configured to” perform a specified function is capable of performing the specified function without alteration, rather than merely having potential to perform the specified function after further modification. In other words, the described component or module, when expressly configured to perform the specified function, is specifically selected, created, implemented, utilized, programmed, and/or designed for the purpose of performing the specified function.

This written description uses examples, including the best mode, to enable those skilled in the art to make and use devices, systems and compositions of matter, and to perform methods, according to this disclosure. It is the following claims, including equivalents, which define the scope of the present disclosure.

What is claimed is:

1. A system for rapid evacuation of fluid components from a battery cell, comprising:
a first puncturing element configured for interfacing with and puncturing a first surface of the battery cell to form a first hole through the first surface, and having a first channel extending through the first puncturing element;
a second puncturing element configured for interfacing with and puncturing a second surface of the battery cell to form a second hole through the second surface, and having a second channel extending through the second puncturing element;
a first pressure source in fluid communication with the first channel via a first conduit and configured to cause a first fluid flow through the first conduit and the first channel;
an evacuation manifold having a housing enclosing a plenum, a manifold inlet and a manifold outlet each formed in the housing and in fluid communication with the plenum with a downstream direction defined from the manifold inlet to the manifold outlet, a through-hole formed in the housing between the manifold inlet and the manifold outlet, a second conduit having a primary end in fluid communication with the through-hole and a secondary end terminating within the plenum downstream of the primary end, and a one-way valve disposed adjacent the secondary end of the second conduit and configured to move between a closed position which prevents flow through the second conduit and an open position which permits flow through the second conduit; and
a second pressure source in fluid communication with the manifold inlet via a third conduit and configured to cause a second fluid flow through the third conduit and the plenum and out the manifold outlet;
wherein the evacuation manifold is configured to interface with the second puncturing element such that the through-hole is placed in fluid communication with the second channel; and
wherein the first and second fluid flows cause the fluid components to flow through the second hole, the second channel and the second conduit and out the manifold outlet.

2. The system of claim 1, wherein the battery cell is a prismatic battery cell or a cylindrical battery cell.

3. The system of claim 1, wherein the first surface is a top surface of the battery cell and the second surface is a bottom surface of the battery cell.

4. The system of claim 1, wherein the first and second surfaces are on a bottom surface of the battery cell.

5. The system of claim 1, wherein at least one of the first puncturing element and the second puncturing element is carried by or incorporated into the evacuation manifold.

6. The system of claim 1, further comprising:
a holding frame having a top platen configured to interface with a top portion of the battery cell and a bottom platen configured to interface with a bottom portion of the battery cell, wherein the top and bottom platens are configured to cooperate together for securing the battery cell against movement.

7. The system of claim 6, wherein the first puncturing element is carried by or incorporated into the top platen, and the second puncturing element is carried by or incorporated into the bottom platen.

8. The system of claim 6, further comprising:
a vibrating member carried by or incorporated into at least one of the top platen and the bottom platen and configured for vibrating the battery cell.

9. The system of claim 1, further comprising:
a first seal carried by the first puncturing element and configured for sealing against the first surface so as to prevent leakage between the first puncturing element and the first surface when the first puncturing element punctures the first surface; and
a second seal carried by the second puncturing element and configured for sealing against the second surface so as to prevent leakage between the second puncturing element and the second surface when the second puncturing element punctures the second surface.

10. The system of claim 1, further comprising:
an accumulator/separator for receiving the fluid components from the manifold outlet and for separating the fluid components into gas components and non-gas components.

11. The system of claim 1, wherein the first fluid flow from the first pressure source comprises at least one of an inert gas and a non-reactive gas that is not reactive with the fluid components or with any internal components of the battery cell.

12. The system of claim 1, further comprising:
an inlet valve disposed in the first fluid flow and configured for at least one of dynamically variable flow and pulsing flow.

13. The system of claim 1, wherein the first and second surfaces are on a bottom wall of the battery cell, wherein the battery cell includes a first internal channel extending in a first leg along the bottom wall from a first closed end at a starting point adjacent the first surface to a first side wall of the battery cell and in a second leg upward along the first side wall to a first open end at a terminating point adjacent a top wall of the battery cell, and wherein the first hole is in fluid communication with the first internal channel.

14. The system of claim 13, wherein the battery cell includes a second internal channel extending along the bottom wall from a second open end at a beginning point adjacent a second side wall generally opposite the first side wall to a second closed end at an ending point that is inward of the second side wall, and wherein the second hole is in fluid communication with the second internal channel.

15. The system of claim 1, wherein the second puncturing element comprises:
a tube having an upper wall, a lower wall, a first end wall at a first end of the tube defining a forward direction, and a second end wall at a second end of the tube defining a rearward direction, wherein the tube is generally sealed except for a tube inlet formed on the first end, a tube outlet formed in the lower wall and a slot formed in the upper wall;
a wedge sealably and slidably disposed within the tube between a forward position and a rearward position with a middle position between the forward and rearward positions, the wedge having a first wedge surface generally facing the forward direction and an upwardly sloping ramp surface generally facing the rearward direction, wherein a tube chamber is defined within the tube between the first end wall and the first wedge surface;
a generally vertical blade having an upper blade portion and a lower blade portion, wherein the lower blade portion is supported upon and is upwardly slidable along the ramp surface;
a piston sealably and slidably disposed within the tube and positioned rearward of the wedge;
a biasing member disposed between the blade and the piston; and
a third pressure source in fluid communication with the tube inlet;
wherein in the forward position, a first pressure is present in the tube chamber, the first wedge surface is disposed forward of the tube outlet and the upper blade portion extends to a first height above the slot;
wherein between the forward position and the middle position, a second pressure that is higher than the first pressure is developed in the tube chamber by the third pressure source, thereby urging the wedge rearward while the piston remains unmoved and compressing the biasing member, thus causing the upper blade portion to extend to a second height above the slot that is greater than the first height, wherein the first wedge surface remains disposed forward of the tube outlet; and
wherein between the middle position and the rearward position, a third pressure that is higher than the second pressure is developed in the tube chamber by the third pressure source, thereby urging the wedge and the piston rearward while the upper blade portion maintains the second height, until the wedge is urged into the rearward position with the first wedge surface being disposed rearward of the tube outlet.

16. A system for rapid evacuation of fluid components from a battery cell, comprising:
a first puncturing element configured for interfacing with and puncturing a first surface of the battery cell to form a first hole through the first surface, and having a first channel extending through the first puncturing element;
a second puncturing element configured for interfacing with and puncturing a second surface of the battery cell to form a second hole through the second surface, and having a second channel extending through the second puncturing element;
a first pressure source in fluid communication with the first channel via a first conduit and configured to cause a first fluid flow through the first conduit and the first channel;
an evacuation manifold having a housing enclosing a plenum, a manifold inlet and a manifold outlet each formed in the housing and in fluid communication with the plenum with a downstream direction defined from the manifold inlet to the manifold outlet, a through-hole formed in the housing between the manifold inlet and the manifold outlet, a second conduit having a primary end in fluid communication with the through-hole and a secondary end terminating within the plenum downstream of the primary end, and a one-way valve disposed adjacent the secondary end of the second conduit and configured to move between a closed position which prevents flow through the second conduit and an open position which permits flow through the second conduit; and
a second pressure source in fluid communication with the manifold inlet via a third conduit and configured to cause a second fluid flow through the third conduit and the plenum and out the manifold outlet;
wherein the second puncturing element comprises:
a tube having an upper wall, a lower wall, a first end wall at a first end of the tube defining a forward direction, and a second end wall at a second end of the tube defining a rearward direction, wherein the tube is generally sealed except for a tube inlet formed on the first end, a tube outlet formed in the lower wall and a slot formed in the upper wall;
a wedge sealably and slidably disposed within the tube between a forward position and a rearward position with a middle position between the forward and rearward positions, the wedge having a first wedge surface generally facing the forward direction and an upwardly sloping ramp surface generally facing the rearward direction, wherein a tube chamber is defined within the tube between the first end wall and the first wedge surface;
a generally vertical blade having an upper blade portion and a lower blade portion, wherein the lower blade portion is supported upon and is upwardly slidable along the ramp surface;
a piston sealably and slidably disposed within the tube and positioned rearward of the wedge;
a biasing member disposed between the blade and the piston; and
a third pressure source in fluid communication with the tube inlet;
wherein (i) in the forward position, a first pressure is present in the tube chamber, the first wedge surface is disposed forward of the tube outlet and the upper blade portion extends to a first height above the slot, (ii) between the forward position and the middle position, a second pressure that is higher than the first pressure is developed in the tube chamber by the third pressure source, thereby urging the wedge rearward while the piston remains unmoved and compressing the biasing member, thus causing the upper blade portion to extend to a second height above the slot that is greater than the first height, wherein the first wedge surface remains disposed forward of the tube outlet, and (iii) between the middle position and the rearward position, a third pressure that is higher than the second pressure is developed in the tube chamber by the third pressure source, thereby urging the wedge and the piston rearward while the upper blade portion maintains the second height, until the wedge is urged into the rearward position with the first wedge surface being disposed rearward of the tube outlet;
wherein the evacuation manifold is configured to interface with the second puncturing element such that the through-hole is placed in fluid communication with the second channel; and
wherein the first and second fluid flows cause the fluid components to flow through the second hole, the second channel and the second conduit and out the manifold outlet.

17. A method for rapidly evacuating fluid components from a battery cell, comprising:
puncturing a first surface of the battery cell with a first puncturing element having a first channel extending therethrough so as to form a first hole through the first surface;
puncturing a second surface of the battery cell with a second puncturing element having a second channel extending therethrough so as to form a second hole through the second surface;
interfacing an evacuation manifold having a housing with a through-hole formed therein with the second puncturing element such that the through-hole is placed in fluid communication with the second channel, wherein the housing encloses a plenum and the evacuation manifold has a manifold inlet and a manifold outlet each formed in the housing and in fluid communication with the plenum with a downstream direction defined from the manifold inlet to the manifold outlet and with the through-hole being disposed between the manifold inlet and the manifold outlet, a second conduit having a primary end in fluid communication with the through-hole and a secondary end terminating within the plenum downstream of the primary end, and a one-way valve disposed adjacent the secondary end of the second conduit and configured to move between a closed position which prevents flow through the second conduit and an open position which permits flow through the second conduit;
causing a first fluid flow through the first channel by using a first pressure source having a first conduit in fluid communication with the first channel; and
causing a second fluid flow through the plenum and out the manifold outlet by using a second pressure source having a third conduit in fluid communication with the manifold inlet;
wherein the first and second fluid flows cause the fluid components to flow through the second hole, the second channel and the second conduit and out the manifold outlet.

18. The method of claim 17, further comprising:
flushing the battery cell with a liquid that is not reactive with the fluid components or with any internal components of the battery cell.

19. The method of claim 18, wherein the flushing of the battery cell includes passing the liquid through the first puncturing element, the battery cell, the second puncturing element and the evacuation manifold.

20. The method of claim 17, further comprising:
vibrating the battery cell by using a vibrating member that is carried by or incorporated into at least one of a top platen and a bottom platen of a holding frame, wherein the top platen is configured to interface with a top portion of the battery cell and the bottom platen is configured to interface with a bottom portion of the battery cell, wherein the top and bottom platens are configured to cooperate together for securing the battery cell against movement.
